(19) United States
(12) Patent Application Publication
(10) Pub. No.: US 2023/0263117 A1
(43) Pub. Date: Aug. 24, 2023

(54) BLENDED HYDROPONICS

(71) Applicant: Jacques Mauritz VAN BUUREN, Southlake, TX (US)

(72) Inventor: Jacques Mauritz VAN BUUREN, Southlake, TX (US)

(21) Appl. No.: 18/012,338

(22) PCT Filed: Jun. 22, 2021
(86) PCT No.: PCT/IB2021/055480

§ 371 Date: Dec. 22, 2022

Related U.S. Application Data
(60) Provisional application No. 63/042,060, filed on Jun. 22, 2020.

(51) Int. Cl. A01G 31/06

(52) U.S. Cl. CPC A01G 31/06

(57) ABSTRACT

This invention relates to blended hydroponics. There is provided a plant growth supply panel, which includes a sheet body having at least one enclosed supply passage extending therein. A plurality of plant receiving stations are arranged through the sheet body, in use each plant receiving station surrounds a growing plant. The panel also includes at least one inlet to the at least one enclosed supply passage and a plurality of outlets from the at least one enclosed supply passage, the plurality of outlets positioned proximate the plurality of plant receiving stations, through which supply fluids are delivered to growing plants in the plant receiving stations in use. The invention also provides for a planting tray onto which the panel fits and a blended hydroponics system.

### FIELD OF THE INVENTION

This invention relates to blended hydroponics. In particular, the invention relates to a plant growth supply panel, a planting tray and a blended hydroponics system.

### BACKGROUND OF THE INVENTION

Hydroponics supply systems differ substantially depending on the type of hydroponics systems employed. Water culture systems represent the simplest of hydroponics systems, wherein plants are supported on floats, the roots immersed in nutrient solution in a reservoir beneath it. Air is provided to roots by means of an air stone or diffuser. Nutrient film techniques utilise channels through which nutrients are provided to the bare roots of plants. The drawback of these hydroponics techniques is the reliance on bulk supply to plant, resulting in a wastage of supplies and energy, even in recycled or recovery systems.

Drip systems attempt to address this, with networks of tubes and drip emitters delivering nutrient solutions directly to individual plants. The major drawback of these hydroponics systems is the transportation and installation of such complex systems. Furthermore, drip systems present further challenges when it comes to harvesting the produce, as disassembly is both time-consuming and labour intensive.

There is thus a need for a blended hydroponics system which creates a micro ecosystem for each plant and in which individual plant supply is possible without complex tubing systems. The inventor is aware of this need and aims to provide a suitable solution with this blended hydroponics invention.

### SUMMARY OF THE INVENTION

Broadly according to a first aspect of the invention there is provided a plant growth supply panel, which includes
a sheet body having at least one enclosed supply passage extending therein;
a plurality of plant receiving stations arranged through the sheet body, in use each plant receiving station surrounds a growing plant;
at least one inlet to the at least one enclosed supply passage; and
a plurality of outlets from the at least one enclosed supply passage, the plurality of outlets positioned proximate the plurality of plant receiving stations, through which supply fluids are delivered to growing plants in the plant receiving stations in use.

The plant receiving stations may be in the form of plant apertures through the sheet body. The number of apertures may be dependent on the number of plants required to be grown through the particular plant growth supply panel.

In use, the plant growth supply panel will be placed on top of a plant support platform, which will support growing plants (from seedlings to full vegetative, flowering or fruiting stage) from below, while the plants grow through and above the plant apertures.

The plant growth supply panel may have an upper face, in use facing the shoot system of the plants, and a lower face, in use facing the root system of the plants.

The at least one enclosed supply passage may be impervious. The at least one enclosed supply passage may be operable to convey any one or more supply fluids. The supply fluids may be selected from any one or more of: fluids, nutrient fluids, gasses, air, liquids, water or the like.

The sheet body may include at least two walls spaced vertically from each other, with connective structures between the at least two walls, thereby providing the at least one enclosed supply passage between the at least two walls and the connective structures. In one embodiment, the connective structures may be defined by areas, paths, lines, patterns or the like, through the sheet body, where the at least two walls are attached to each other.

The at least one enclosed supply passage may be in the form of a manifold of ducts formed within the sheet body, through which supply fluids are delivered to the plurality of plant receiving stations.

The at least one enclosed supply passage may be in the form of a chamber formed within the sheet body.

The plant growth supply panel may include a plurality of enclosed supply passages, each enclosed supply passage having a separate inlet and plurality of separate outlets. Advantageously, different mediums may be supplied through the different enclosed supply passages. For example, the inlet of one enclosed supply passage may be connected to an air supply, thus supplying air through its outlets, while the inlet of a second enclosed supply passage may be connected to a nutrient supply, thus supplying nutrients through its outlets. Thus, a single plant growth supply panel may supply all plant growth requirements.

In one embodiment, the first enclosed supply passage may be in the form of a manifold of ducts for transporting liquids. The second supply passage may be in the form of an air chamber formed around the manifold of ducts for transporting air or gasses.

In another embodiment, the first enclosed supply passage may be in the form of a manifold of ducts for transporting liquids and the second supply passage may be in the form of a manifold of ducts for transporting air or gasses. Specifically, the first enclosed supply passage may be in the form of an upper manifold of ducts and the second enclosed supply passage may be in the form of a lower manifold of ducts, each manifold forming a different supply line. The upper manifold may supply air or gases and the lower manifold may supply liquid nutrients.

In both embodiments, the inlet of the first enclosed supply passage may define a liquid inlet. The plurality of outlets from the first enclosed supply passage may define a plurality of liquid outlets. The plurality of liquid outlets may be located at the plurality of plant receiving stations.

In both embodiments, the inlet of the second enclosed supply passage may define an air inlet. The air inlet may be located through an upper wall of the at least two walls. The plurality of outlets from the second enclosed supply passage may define a plurality of air outlets. The plurality of air outlets may include groups of air outlets located proximate each plant receiving station of the plurality of plant receiving stations.

The plant growth supply panel may include at least one aerator being operable to diffuse an airstream to increase gas and/or oxygen solubility. The at least one aerator may be in the form of any one or more of: an air stone, an air diffuser or the like. The aerator may be connected in flow communication with one of the at least one enclosed supply passages. In particular, in flow communication with the air supply passage.

The plant growth supply panel may include at least one mister connection formations in flow communication with one of the at least one enclosed supply passages. In particular, in flow communication with the nutrient/liquid supply passage. The plant growth supply panel may also include one or more misters connected to the at least one mister connection formations. The mister connection formations may be positioned on the bottom face of the plant growth supply panel, such that in use they provide mist irrigation to the roots of plants in the plurality of plant receiving stations.

The plurality of plant apertures may each include a sloped surface through which at least one liquid outlet of the plurality of liquid outlets may be provided, in use to provide liquid angled downward or into the plant apertures.

The sheet body may be planar. The sheet body may be rectangular.

The plant growth supply panel may be in the form of a lid, specifically a lid for a planting tray. The lid may include connectors for connecting the lid to the planting tray in use. The connectors may be in the form of clips, spigot/socket connectors, toggle latches, friction formations, a lipped rim or the like.

Alternatively, the plant growth supply panel may be in the form of an overlay for a planting tray.

The plant growth supply panel may be manufactured of plastic, silicon or the like. The plant growth supply panel may be manufactured by means of blow moulding, thermoforming or the like.

According to another aspect of the invention, there is provided a planting tray which includes
a base with a rim which is raised;
a plurality of plant supports spaced apart over the base; and
a reservoir formed between the rim and the plurality of plant supports.

In use, the plant supports may be shaped and dimensioned to support a seed starter plug, through to a full vegetative, flowering and/or fruiting plant.

The plurality of plant supports may be shaped as conical frustums. The plurality of plant supports may be arranged as a series of rows.

The plurality of plant supports may define a matrix of plant supports. In one embodiment, the plurality of plant supports may be integrated with the base. In another embodiment, the plant supports may be retrofitted onto the base. In such an embodiment, rows of plant supports may be manufactured separately, and attached to the base.

Each plant support may include a plant engaging device. The plant engaging device may be located atop the plurality of plant supports. The plant engaging devices may be in the form of any one or more of a fork, an indentation, or the like, provided on each plant support. The fork may include two spaced-apart prongs supported by a base. The indentation, in use may provide a small water reservoir or pond on each plant support.

The planting tray may include complementary connectors for connecting the planting tray to a plant growth supply panel. The position of the plant supports of the planting tray may match the position of the plant receiving stations of the plant growth supply panel, such that when the lid is connected to the tray, each plant receiving station overlays a plant support.

The rim may include at least one waste outlet. In particular, the rim of the tray may include a plurality of waste outlets at different height levels of the rim.

A further aspect of the invention provides a blended hydroponics system which includes
at least one planting tray, as described; and
at least one plant growth supply panel, as described, connected above the planting tray such that the plurality of plant receiving stations of the plant growth supply panel are positioned above the plurality of plant supports of the planting tray, in use the plurality of outlets from the at least one enclosed supply passage delivering supply fluids to seeds/plants supported on the plant engaging devices.

The hydroponics system may further include any one or more of: an air supply, water supply, nutrient supply or the like, connectable to inlets of the one or more enclosed supply passages. The hydroponics system may also include a waste extractor, connectable to the at least one waste outlet.

The blended hydroponics system may define any one or combination of: an aeroponics zone, a nutrient film technique zone and a deep water culture zone.

The invention is now described, by way of non-limiting example, with reference to the accompanying figures:

### FIGURE(S)

In the figure(s):

FIG. 1 shows various views of a plant growth supply panel in accordance with one aspect of the invention, with FIG. 1.1 showing a top view, FIG. 1.2 showing a top three-dimensional view, FIG. 1.3 showing a bottom three-dimensional view,

FIG. 1.4 showing a side view from one side, FIG. 1.5 showing a side view from another side, FIG. 1.6 showing a top view of an area proximate a plant receiving station of the plant growth supply panel, FIG. 1.7 showing an enlarged bottom view of the plant receiving station shown in FIG. 1.6 and FIG. 1.8 showing a cutaway view of a mister connection formation on the lower face of the plant growth supply panel;

FIG. 2 shows various views of a planting tray which is complementary to the plant growth supply panel shown in FIG. 1, in accordance with a further aspect of the invention, with FIG. 2.1 showing a top view, FIG. 2.2 showing a top three-dimensional view, FIG. 2.3 showing a bottom three-dimensional view, FIG. 2.4 showing a side view from one side, FIG. 2.5 showing a side view from another side and FIG. 2.6 showing a top three-dimensional view of a plurality of plant supports provided in the planting tray shown in FIGS. 2.1 to 2.5;

FIG. 3 shows various views of a blended hydroponics system in accordance with a further aspect of the invention, with FIG. 3.1 showing a three-dimensional view,

FIG. 3.2 showing a top view, FIG. 3.3 showing a side view from one side, FIG. 3.4 showing a side view from another side and FIG. 3.5 showing a cutaway view of the blended hydroponics system; and

FIG. 4 shows a three-dimensional view of an example of a blended hydroponics system in use on a vertical support.

In the figures, like reference numerals denote like parts of the invention unless otherwise indicated.

### EMBODIMENT OF THE INVENTION

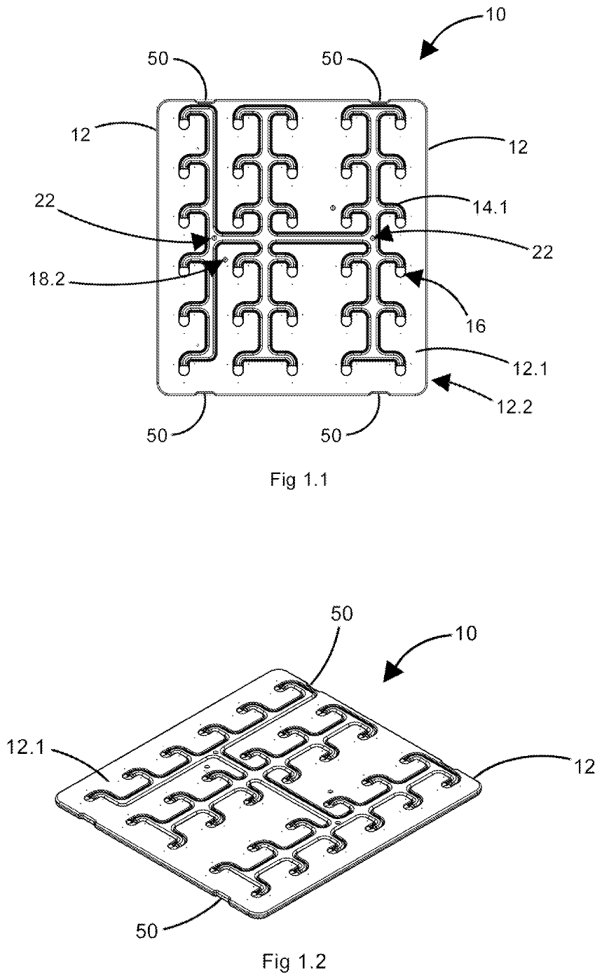

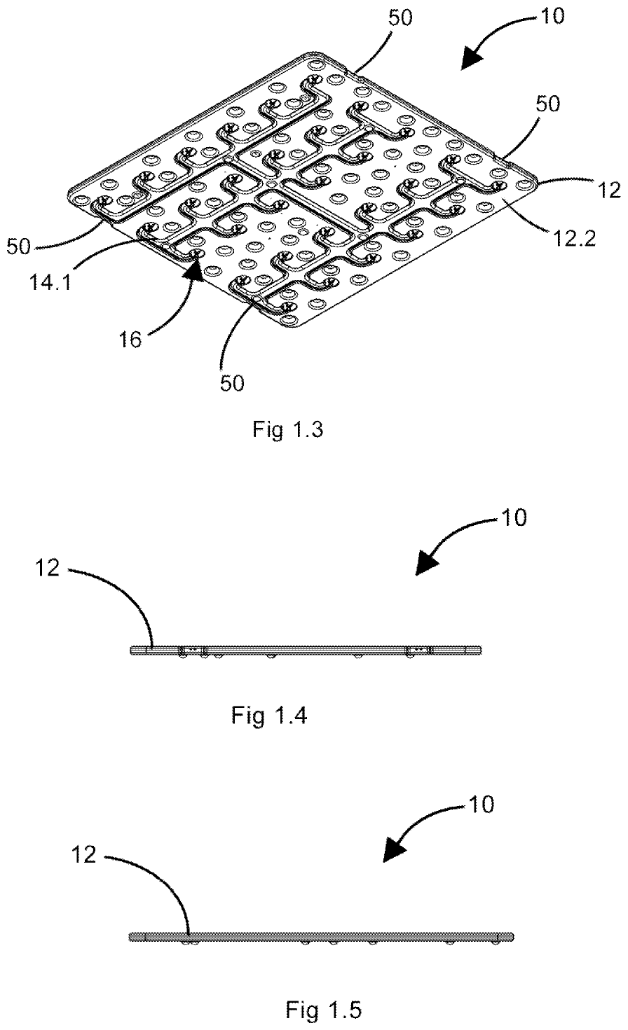

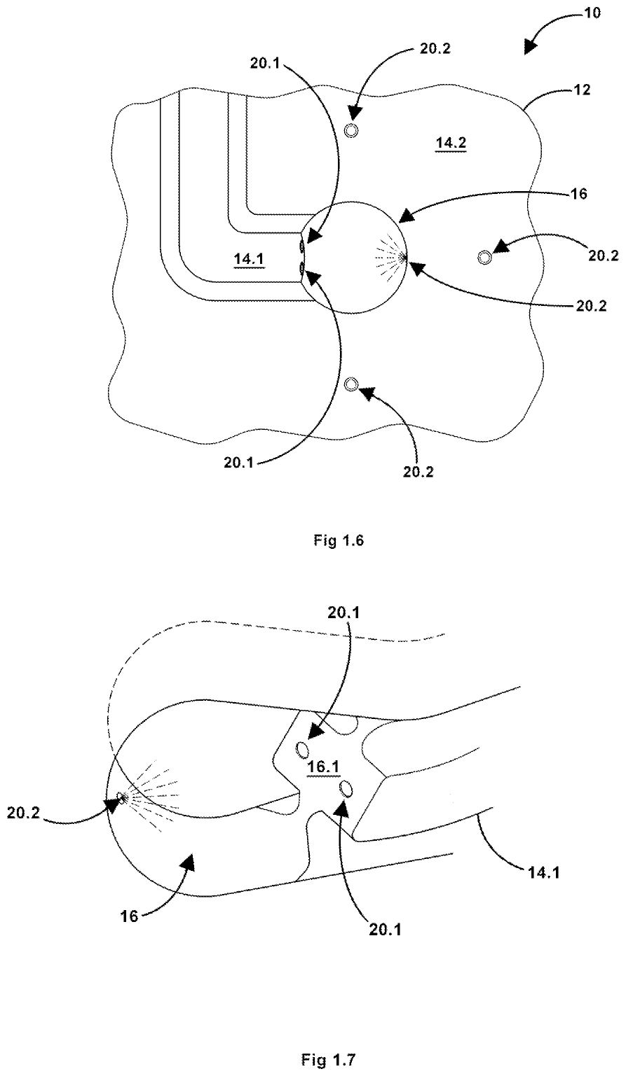

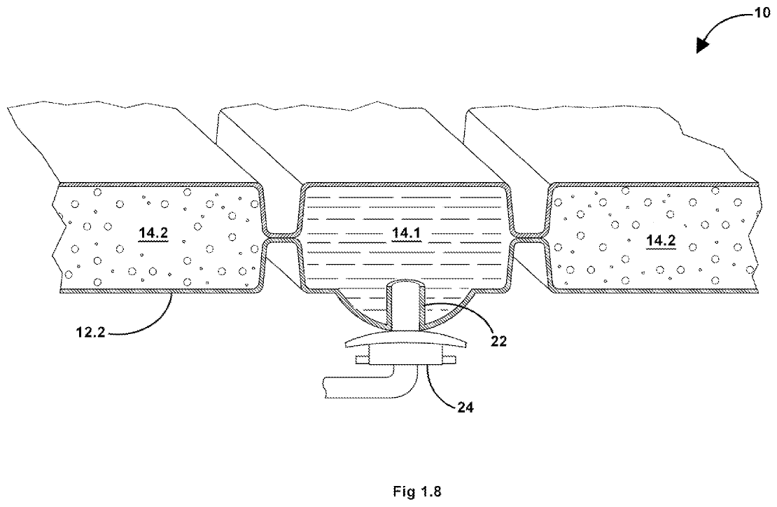

As shown in FIG. 1, reference numeral 10 indicates a plant growth supply panel, in accordance with a first aspect of the invention.

The plant growth supply panel (10) includes:
a sheet body (12) which has at least one enclosed supply passage (14) extending therein;
a plurality of plant receiving stations (16) arranged through the sheet body (12), in use each plant receiving station surrounding a growing plant;
at least one inlet (18) to the at least one enclosed supply passage (14); and
a plurality of outlets (20) from the at least one enclosed supply passage (14), the plurality of outlets (20) positioned proximate the plurality of plant receiving stations (16), through which supply fluids are delivered to growing plants in the plant receiving stations (16) in use.

The plant growth supply panel (10) is used to supply fluids to growing plants, from pods to seedlings to full vegetative, flowering or fruiting stage. In use, the plant growth supply panel (10) is placed on top of a plant support platform, such as a planting tray (not shown here), which supports plants from below, while the plants grow through and above the plurality of plant receiving stations (16). The plant receiving stations (16) are in the form of plant apertures through the sheet body (12), and the number of plant apertures (16) is dependent on the number of plants required to be grown through the particular plant growth supply panel (10).

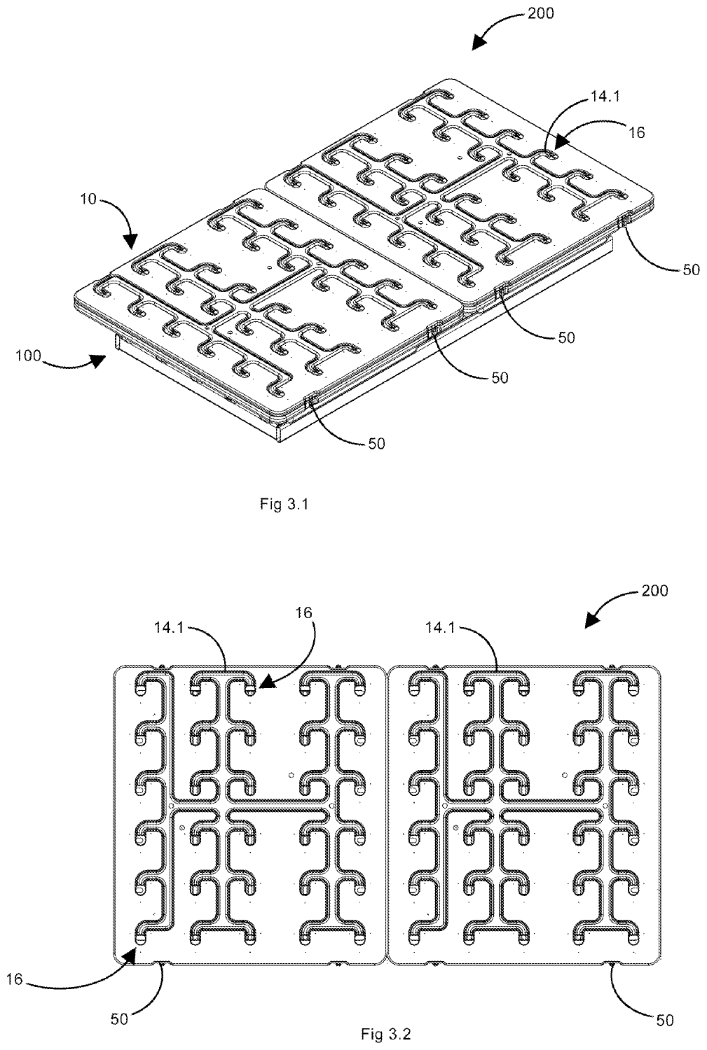

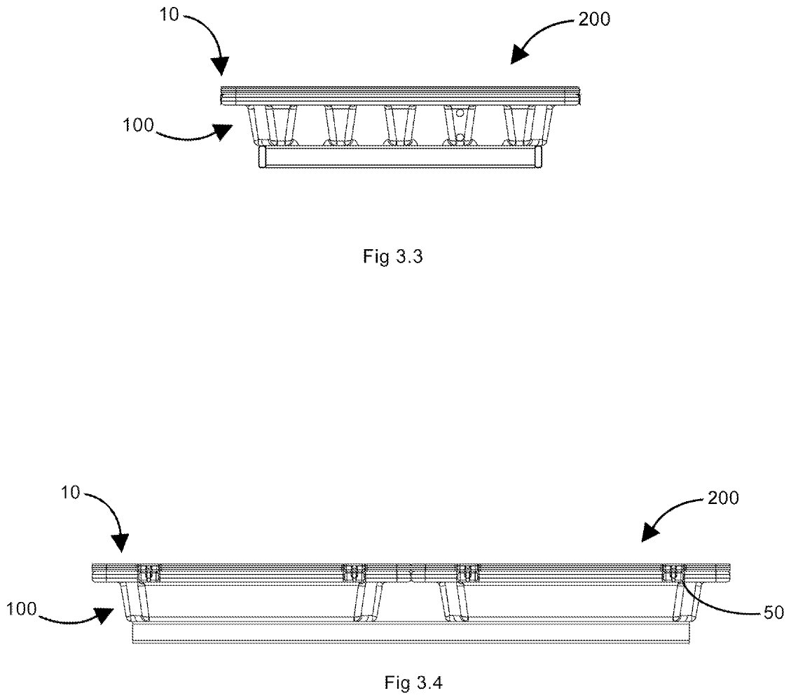

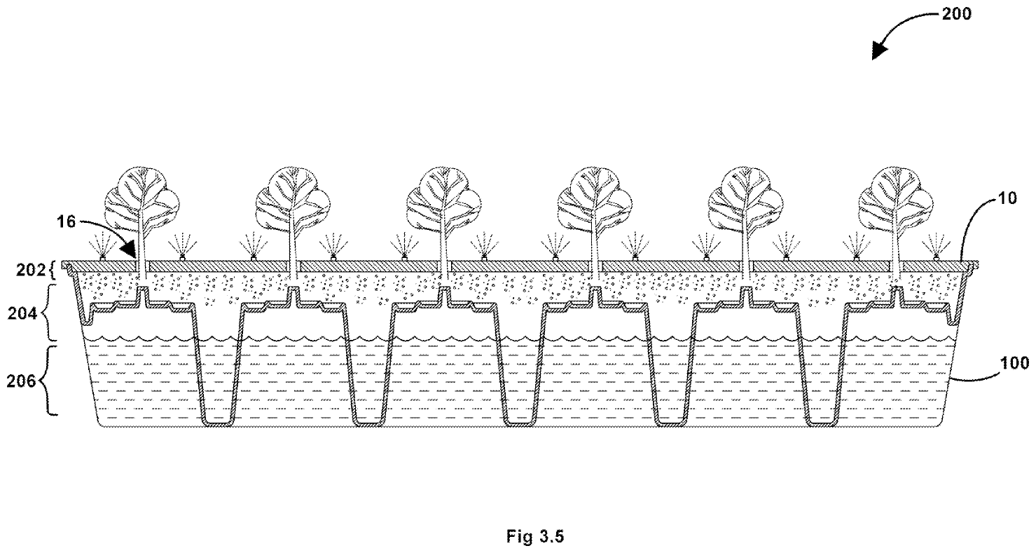

As best shown in FIGS. 1.2 and 1.3, the sheet body (12) is planar and rectangular, and includes an upper face (12.1), in use facing the shoot system of the growing plants, and a lower face (12.2), in use facing the root system of the growing plants. The sheet body (12) includes two horizontally-orientated walls spaced vertically from each other, with connective structures between the two walls (not specifically shown here—refer to cutaway view shown in FIG. 3.5). In this example, the connective structures are defined by paths through the sheet body (10) where the two walls are attached to each other. As such, the wall and connective structures provide the at least one enclosed supply passage (14) between them.

The at least one enclosed supply passage (14) is impervious and is operable to convey any one or more supply fluids selected from: nutrient fluids and gasses or air. Advantageously, different mediums can be supplied through the different enclosed supply passages such that a single plant growth supply panel (10) can supply all plant growth requirements.

In this particular example of the plant growth supply panel (10) shown in FIGS. 1 and 3, the at least one enclosed supply passage (14) includes two enclosed supply passages (14.1, 14.2) formed within the sheet body (12). The first enclosed supply passage (14.1) is in the form of a manifold of ducts (14.1) for transporting liquid nutrients and the second supply passage (14.2—shown best in the cutaway view of FIG. 3.5) is in the form of an air chamber (14.2) formed around the manifold of ducts (14.1) for transporting air or gasses.

Each enclosed supply passage (14.1, 14.2) has a separate at least one inlet (18.1—not specifically shown in this example but positioned on one side of the sheet body, 18.2) and a plurality of separate outlets (20.1, 20.2) through which all necessary supply fluids are delivered to the plant apertures (16). It is to be appreciated that the number of inlets (18.1—not shown, 18.2) and outlets (20.1, 20.2) can vary depending on the size of the plant growth supply panel (10).

As show in FIG. 1.1, the manifold of ducts (14.1) is arranged as a series of three interconnected ducts which each include multiple two-way branches. The inlet (18.1—not shown) of the manifold of ducts (14.1) is a liquid inlet and the plurality of outlets (20.1) from the manifold of ducts (14.1) are in the form of liquid outlets (20.1). The liquid inlet is connected to a nutrient supply (not shown), thus supplying liquid nutrients to the manifold of ducts (14.1). As best shown in FIGS. 1.7 and 1.8, the liquid outlets (20.1) are located at the end of each branch at the plant apertures (16), in use to supply the liquid nutrients directly to the base of the plants therein. Specifically referring to FIG. 1.7, each plant aperture (16) includes a sloped surface (16.1) through which two liquid outlets (20.1) are provided, in use to provide liquid nutrients angled downward or into the plant apertures (16), thus dripping onto the seed starter plug or growth medium and later, the roots of the plants.

As best shown in FIG. 1.6, the inlet (18.2) of the air chamber (14.2) is an air inlet (18.2) which is located through the upper wall (12.1) of the sheet body (12). The air inlet (18.2) is connected to an air supply (not shown), thus supplying air to the air chamber (14.2) under a controlled pressure. The plurality of outlets (20.2) from the air chamber (14.2) are in the form of air outlets (20.2). In this example, groups of three air outlets (20.2) are located proximate each plant aperture (16) to supply controlled air to the upper body of the plants. Another air outlet (20.2) is also located within each plant aperture (16), as shown.

In this example, the plant growth supply panel (10) also includes two aerators in the form of air stones (not shown), which are operable to diffuse an airstream to increase gas and/or oxygen solubility. The air stones are each connected in flow communication with the air chamber (14.2) supplying air/gases.

As best shown in FIG. 1.8, the plant growth supply panel (10) further includes two mister connection formations (22) in flow communication with the manifold of ducts (14.1) supplying liquid nutrients. The mister connection formations (22) are positioned on the bottom face (12.2) of the plant growth supply panel (10). As shown, the plant growth supply panel (10) includes two misters (24) connected to the two mister connection formations (22) which in use, provide nutrient mist irrigation to the roots of plants in the plant apertures (16). It is to be appreciated that the number of misters can vary depending on the size of the plant growth supply panel (10) or the desired saturation of roots.

Advantageously, the inclusion of the misters results in the roots of plants in the plant apertures (16) receiving nutrient liquid from two separate sources: the liquid outlets (20.1) from an upper level and from the misters at a lower level.

In this example, the plant growth supply panel (10) is in the form of a lid for a planting tray. The plant growth supply panel lid (10) includes connectors (50) for connecting the lid (20) to a planting tray in use (see FIG. 3). The connectors (50) shown here are in the form of a lipped rim.

The plant growth supply panel lid (10) is manufactured of plastic by means of blow moulding and/or thermoforming, thus is relatively cost—and time effective to manufacture.

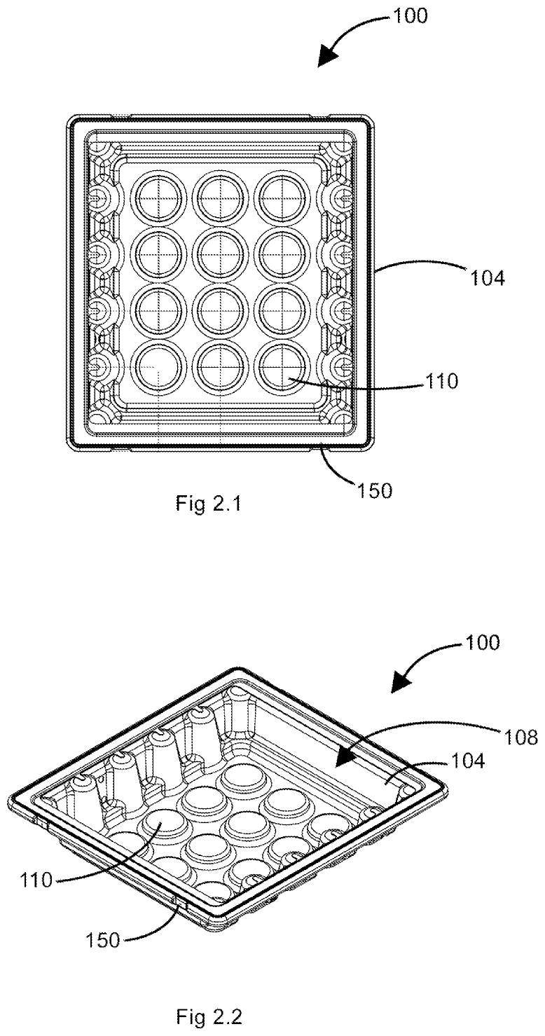

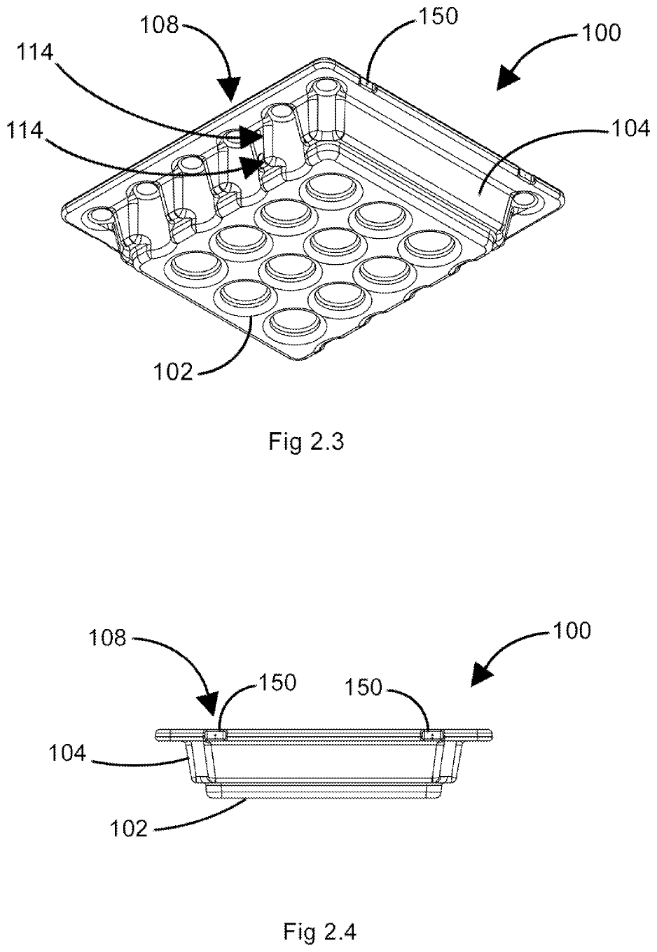

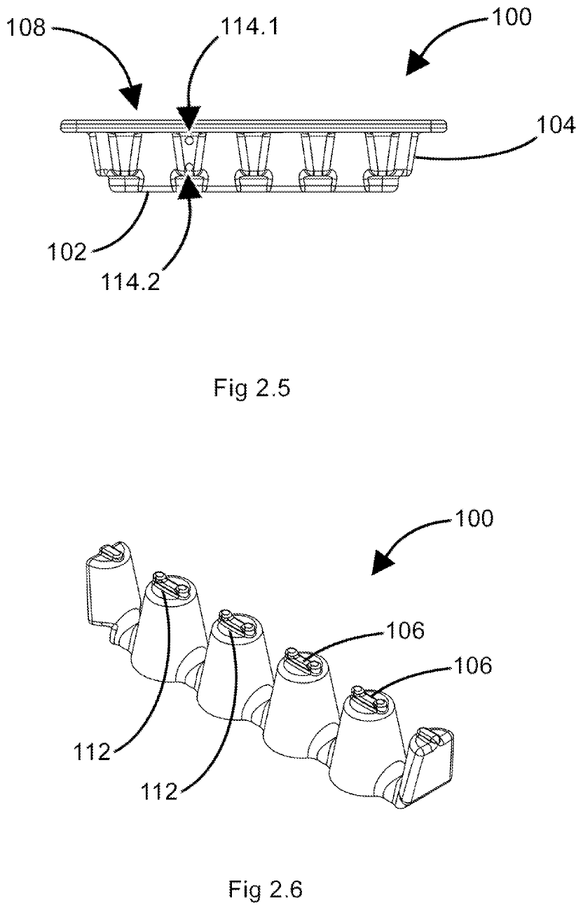

In FIG. 2, reference numeral 100 refers to a planting tray, in accordance with a further aspect of the invention. The planting tray (100) includes a base (102) with a rim (104) which is raised, a plurality of plant supports (106) spaced apart over the base (102), and a reservoir (108) formed between the rim (104) and the plurality of plant supports (106).

As best shown in FIG. 2.6, the plurality of plant supports (106) are shaped as conical frustums, specifically shaped and dimensioned to support a seed starter plug, through to a full vegetative, flowering and/or fruiting plant in use. In this example, the plurality of plant supports (106) are manufactured and provided separate from the base (102) and are retrofitted onto the base (102) in a matrix (or series of rows) when in use. The base (102) includes a plurality of substantially convex substructures (110) which provide the matrix pattern and to which the plurality of plant supports (106) are connected.

Each plant support (106) includes a plant engaging device (112) in the form of a fork, located atop each plant support (106). The fork (112) includes two circular, spaced-apart prongs supported by a rectangular base, and is specifically designed to support a seed starter plug throughout plant growth. As the seed starter plug is positioned above the prongs, a void is created between the seed starter plug and the plant support (106) in which root growth can commence. In an alternative embodiment (not shown), each plant support (106) may include a plant engaging device in the form of an indentation atop the plant support (106), such that in use, a little pond is formed in the indentation on top of each plant support (106).

The planting tray (100) includes complementary connectors (150) for connecting the planting tray (100) to a plant growth supply panel (10) like the one shown in FIG. 1. When connected, the position of the plant supports (106) match the position of the plant apertures (16) in the plant growth supply panel, such that each plant aperture (16) overlays a plant support (106) and each seed starter plug will receive nutrients and air/gases from the respective outlets (20.1, 20.2).

Nutrient liquids from the liquid outlets (20.1) and the misters is collected in the reservoir (109) of the planting tray (100) as waste. As shown best in FIG. 2.5, the rim (104) includes two waste outlets (114) at different height levels of the reservoir (108). In particular, the rim includes an upper waste outlet (114.1) and a lower waste outlet (114.2), which in use are utilised depending on the desired hydroponics type required.

In FIG. 3, reference numeral 200 refers to a blended hydroponics system, in accordance with yet a further aspect of the present invention. The blended hydroponics system (200) includes at least one planting tray (100), as shown in FIG. 1, and at least one plant growth supply panel (10), as shown in FIG. 2. The at least one plant growth supply panel (10) is connected above the at least one planting tray (100) such that the plurality of plant apertures (16) in the plant growth supply panel (10) are positioned above the plurality of plant supports (106) of the planting tray (100). In use, the plurality of outlets (20.1, 20.2) from the manifold of ducts (14.1) and the air chamber (14.2) deliver liquid nutrients and air/gases (respectively) to the seed starter plugs and/or plants supported on the plant engaging devices (112).

The blended hydroponics system (200) also includes a nutrient supply (not shown) which in use is connected to the liquid inlet (18.1—not shown) and an air supply (also not shown) which in use is connected to the air inlet (18.2).

All nutrient liquid from the liquid outlets (20.1) of the at least one plant growth supply panel (10) and from the misters of the at least one plant growth supply panel (10) is collected in the reservoir (108) of the at least one planting tray (100). It is then extracted as waste at either the upper waste outlet (114.1) or at the lower waste outlet, depending on how the reservoir (108) is used to achieve a particular type of hydroponics. The hydroponics system (200) further includes a waste extractor (not shown) which in use is connected to the upper or lower waste outlet (114.1, 114.2) to extract waste nutrient liquids.

FIG. 3.5 shows a cutaway view of the blended hydroponics system (200), illustrating the integration between the at least one plant growth supply panel (10) and the at least one planting tray (100).

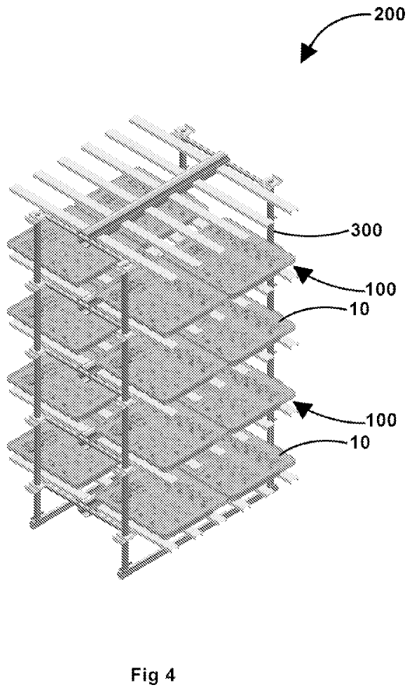

FIG. 4 shows an example of the blended hydroponics system (200) having a plurality of plant growth supply panels (10) and planting trays (100) assembled in a vertical arrangement, specifically in a vertical stand (300). This system (200) maximises surface area usage for growing.

Advantageously, the blended hydroponics system (200) is typically utilised in the following ways:
During early stages of seedling growth, the seed starter plugs and/or seedling roots are not submerged in nutrient liquid. Instead, an aeroponics system is utilised, in which the seed starter plugs and/or seedling roots which are supported on the plant engaging devices (112) grow in air as the growing medium, and nutrients are supplied predominantly by the misters. This is shown by the aeroponics zone indicated by reference numeral 202.
During young, vegetative growth, the roots of the plants will pond on top of the plant supports (106) of the planting tray (100), beneath the plant engaging devices (112), thus utilising a nutrient film technique (NFT) for nutrient flow. This is shown by the nutrient film technique zone indicated by reference numeral 204.
During the full vegetative, flowering and/or fruiting stage, the roots of the plants are fully submerged in nutrient liquid, thereby boosting growth utilising deep water culture. Specifically, the planting tray (100) is filled to the upper waste outlet (114.1) whilst the lower waste outlet (114.2) is blocked. This is shown by the deep water culture zone indicated by reference numeral 206.
Once plants are fully matured and ready for harvesting, the nutrient liquid is drained from the reservoir (108) by unblocking the lower waste outlet (114.2). This reduces the weight of the blended hydroponics system (200) allowing it to be moved to a harvesting station.

After the nutrient fluid has been drained, each plant growth supply panel (10) is simply disconnected from its planting tray (100) using the connectors (50, 150). As roots grow freely in the open reservoir (108)—not in fixed plant holders as used traditionally—it is effortless and straightforward to separate the plant growth supply panel (10) from its planting tray (100). The plant growth supply panel (10), which holds the plants, can be rotated 90 degrees to a vertical orientation and the upper plant bodies or lower root systems harvested with ease. Harvesting can even be robotically performed.

The inventor believes that the invention provides a novel plant growth supply panel which allows for the creation of a micro ecosystem for each plant and in which individual plant supply is possible without complex tubing systems. The invention further provides a planting tray which is complementary to the plant growth supply panel and which together, forms a unique hydroponics system which can be utilized for a variety of types of hydroponics, including at least aeroponics, nutrient film technique (NFT) and deep water culture.

1-51. (canceled)

52. A plant growth supply panel, which includes
a sheet body having at least one enclosed supply passage extending therein;
a plurality of plant receiving stations arranged through the sheet body, in use each plant receiving station surrounds a growing plant;
at least one inlet to the at least one enclosed supply passage; and
a plurality of outlets from the at least one enclosed supply passage, the plurality of outlets positioned proximate the plurality of plant receiving stations, through which supply fluids are delivered to growing plants in the plant receiving stations in use.

53. The plant growth supply panel as claimed in claim 52, in which the plant growth supply panel has an upper face, in use facing the shoot system of the plants, and a lower face, in use facing the root system of the plants.

54. The plant growth supply panel as claimed in claim 52, in which the sheet body includes at least two walls spaced apart, with connective structures between the at least two walls, thereby providing the at least one enclosed supply passage between the at least two walls and the connective structures.

55. The plant growth supply panel as claimed in claim 52, in which the at least one enclosed supply passage is in the form of a manifold of ducts formed within the sheet body, through which supply fluids are delivered to the plurality of plant receiving stations.

56. The plant growth supply panel as claimed in claim 52, which includes a plurality of enclosed supply passages, each enclosed supply passage having a separate inlet and plurality of separate outlets, in use, different mediums are supplied through the different enclosed supply passages.

57. The plant growth supply panel as claimed in claim 56, which includes a first enclosed supply passage in the form of a liquid supply passage in use supplying nutrients through its outlets, and a second supply passage in the form of an air or gasses supply passage in use supplying air through its outlets.

58. The plant growth supply panel as claimed in claim 57, in which the inlet of the first enclosed supply passage defines a liquid inlet and the plurality of outlets from the first enclosed supply passage define a plurality of liquid outlets, the plurality of liquid outlets being located at the plurality of plant receiving stations.

59. The plant growth supply panel as claimed in claim 52, which includes at least one aerator being operable to diffuse an airstream to increase gas and/or oxygen solubility.

60. The plant growth supply panel as claimed in claim 52, which includes at least one mister connection formations in flow communication with one of the at least one enclosed supply passages.

61. The plant growth supply panel as claimed in claim 52, in which the sheet body is planar.

62. The plant growth supply panel as claimed in claim 52, in which the plant growth supply panel is in the form of a lid, specifically a lid for a planting tray.

63. A planting tray which includes
a base with a rim which is raised;
a plurality of plant supports spaced apart over the base; and
a reservoir formed between the rim and the plurality of plant supports.

64. The planting tray as claimed in claim 63, in which each plant support includes a plant engaging device.

65. The planting tray as claimed in claim 64, in which the plant engaging device is selected form of any one or both of: a fork and an indentation provided on each plant support.

66. A blended hydroponics system which includes
at least one planting tray, which includes
a base with a rim which is raised;
a plurality of plant supports spaced apart over the base; and
a reservoir formed between the rim and the plurality of plant supports; and
at least one plant growth supply panel, which includes
a sheet body having at least one enclosed supply passage extending therein;
a plurality of plant receiving stations arranged through the sheet body, in use each plant receiving station surrounds a growing plant;
at least one inlet to the at least one enclosed supply passage; and
a plurality of outlets from the at least one enclosed supply passage, the plurality of outlets positioned proximate the plurality of plant receiving stations, through which supply fluids are delivered to growing plants in the plant receiving stations in use, the plant growth panel connected above the planting tray such that the plurality of plant receiving stations of the plant growth supply panel are positioned above the plurality of plant supports of the planting tray, in use the plurality of outlets from the at least one enclosed supply passage delivering supply fluids to seeds/plants supported on the plant engaging devices.
